(19) United States
(12) Patent Application Publication
(10) Pub. No.: US 2026/0362049 A1
(43) Pub. Date: Nov. 12, 2026

(54) EARPHONE SPEAKER STRUCTURE

(71) Applicant: Dongguan Shuoer Acoustic Technology Co., LTD, Dongguan (CN)

(72) Inventors: Yong Du, Dongguan (CN); Biwen Yao, Dongguan (CN); Zhifu Xu, Dongguan (CN)

(21) Appl. No.: 19/656,148

(22) Filed: Apr. 23, 2026

(30) Foreign Application Priority Data
May 9, 2025 (CN) 202520908371.3

(51) Int. Cl. H04R 1/28; H04R 1/02; H04R 1/10; H04R 7/04

(52) U.S. Cl. CPC H04R 1/2888; H04R 1/023; H04R 1/1058; H04R 7/04

(57) ABSTRACT

The present disclosure provides an earphone speaker structure, including an upper magnetic ring frame, a lower magnetic ring frame, a diaphragm assembly, and a plurality of magnetic rings, where the plurality of magnetic rings include an upper central magnetic ring and a lower central magnetic ring, an upper small magnetic ring and a lower small magnetic ring, an upper middle magnetic ring and a lower middle magnetic ring, and an upper large magnetic ring and a lower large magnetic ring, which form two groups of magnetic ring structures corresponding vertically to each other; a 3M sealant is disposed on upper and lower sides of the diaphragm assembly for hermetic assembly between the upper magnetic ring frame and the lower magnetic ring frame. Through the high-precision molded plastic material and the newly designed 3M adhesive sealing structure, the assembly clearance of the speaker is precisely controlled, thereby reducing acoustic distortion.

### CROSS-REFERENCE TO RELATED APPLICATIONS

This application claims priority to Chinese Patent Application No. 202520908371.3, filed on May 9, 2025, which is hereby incorporated by reference in its entirety.

### TECHNICAL FIELD

The present disclosure relates to the technical field of audio equipment, and more particularly to an earphone speaker structure with an outer diameter of 8 mm, 11 mm or 15 mm.

### BACKGROUND

Conventional planar speakers are deficient in terms of assembly accuracy, electrical performance and production efficiency. For example, inaccurate assembly gaps may result in sound distortion, while poor contact in the copper dot contact scheme may cause electrical failures. Therefore, it is necessary to provide a planar speaker with a more optimized structure and more stable performance.

### SUMMARY

In view of this, the present disclosure provides an earphone speaker structure.

To achieve the above objective, the present disclosure adopts the following technical solutions:

An earphone speaker structure, including: an upper magnetic ring frame and a lower magnetic ring frame, which mate precisely by providing six snap-fit positions; a diaphragm assembly, disposed between the upper magnetic ring frame and the lower magnetic ring frame; and
a plurality of magnetic rings, including an upper central magnetic ring and a lower central magnetic ring, an upper small magnetic ring and a lower small magnetic ring, an upper middle magnetic ring and a lower middle magnetic ring, and an upper large magnetic ring and a lower large magnetic ring, which form two groups of magnetic ring structures corresponding vertically to each other, where the magnetic rings of each group have a uniform thickness in the horizontal direction, and diameters thereof increase sequentially from an inner side to an outer side, and the magnetic rings are sequentially mounted in a concentric annular structure in the upper magnetic ring frame and the lower magnetic ring frame in the vertical direction; a 3M sealant is disposed on upper and lower sides of the diaphragm assembly for hermetic assembly between the upper magnetic ring frame and the lower magnetic ring frame and the diaphragm assembly is a double-sided circuit planar diaphragm, and welding leads are of a direct welding structure.

In a preferred technical solution, the 3M sealant hermetically adheres the diaphragm assembly to the lower magnetic ring frame, thereby forming a first sound cavity; and an upper cover is disposed on an outer side of the upper magnetic ring frame, and the upper cover is hermetically connected to the upper magnetic ring frame by dispensing an adhesive, thereby forming a second sound cavity, such that the speaker is constructed as a closed dual-sound-cavity structure.

In a preferred technical solution, the upper magnetic ring frame and the lower magnetic ring frame are respectively provided with a plurality of layers of concentric annular grooves corresponding to sizes of the magnetic rings at all levels, and the magnetic rings are mounted in a nested manner with adhesive dispensing, thereby avoiding misalignment and loosening.

In a preferred technical solution, the six snap-fit positions include six snap fasteners and six snap grooves horizontally wound on the upper magnetic ring frame and the lower magnetic ring frame to improve connection stability.

In a preferred technical solution, an assembly tolerance of the snap-fit positions is controlled within a range of ±0.01 mm to improve assembly precision.

In a preferred technical solution, the 3M sealant is of an annular encapsulation structure to ensure sealing performance and anti-vibration performance.

In a preferred technical solution, a protective steel mesh is disposed on an outer side of the lower magnetic ring frame for preventing dust and preventing foreign matter from entering.

In a preferred technical solution, a tuning mesh for regulating a ventilation rate of the speaker is disposed on an outer side of the upper magnetic ring.

In a preferred technical solution, an outer diameter of the speaker structure is 8 mm, 11 mm or 15 mm, which is suitable for integrated assembly of different types of earphones.

It can be known from the above technical solutions that, compared with the prior art, the present disclosure has the following beneficial technical effects:

Improvement of the assembly precision: Through the high-precision molded plastic material and the newly designed 3M adhesive sealing structure, the assembly clearance of the speaker is precisely controlled, thereby reducing acoustic distortion.

Improvement of electrical performance: The diaphragm assembly adopts a direct-welded lead design, which improves electrical performance and consistency, and reduces failures caused by poor contact and oxidation.

Improvement of production efficiency: The optimized structural design and process flow improve the production efficiency and lower the production cost.

### BRIEF DESCRIPTION OF THE DRAWINGS

To provide a clearer understanding of the technical solutions of the embodiments of the present disclosure or the prior art, a brief introduction to the drawings used in the description of the embodiments or the prior art is provided below. Obviously, the drawings depicted below are merely embodiments of the present disclosure, and those of ordinary skill in the art may obtain additional drawings based on the provided drawings without creative effort.

FIG. 1 is an exploded structural schematic view of the present disclosure.

FIG. 2 is a cross-sectional structural schematic view of the present disclosure.

Reference numerals: 1, upper cover; 2, tuning mesh; 3, upper magnetic ring frame; 4, upper large magnetic ring; 5, upper central magnetic ring; 6, upper small magnetic ring; 7, upper central magnetic ring; 8, diaphragm assembly; 9, 3M sealant; 10, lower central magnetic ring; 11, lower small magnetic ring; 12, lower middle magnetic ring; 13, lower large magnetic ring; 14, lower magnetic ring frame; 15, protective steel mesh; 101, snap fastener; 102, snap groove.

### DESCRIPTION OF EMBODIMENTS

The present disclosure will be further described in detail below in conjunction with drawings. These drawings are merely simplified schematic diagrams, which illustrate the basic structure of the present invention in a schematic manner, and therefore only show the constituents related to the present disclosure.

In the description of the present application, it should be understood that the orientation or positional relationships indicated by the terms “longitudinal”, “radial”, “length”, “width”, “thickness”, “upper”, “lower”, “left”, “right”, “front”, “rear”, “vertical”, “horizontal”, “top”, “bottom”, “inner”, “outer” and the like are based on the orientation or positional relationships shown in the drawings. These terms are used only for the convenience of describing the present application and simplifying the description, rather than indicating or implying that the device or element referred to must have a specific orientation, be constructed and operated in a specific orientation, and therefore should not be construed as limitations on the present application. In the description of the present application, the term “plurality” means two or more, unless otherwise specified.

In the description of the present application, it should be noted that, unless otherwise explicitly specified and limited, the terms “mounted”, “connected” and “coupled” shall be understood in a broad sense. For example, they may refer to a fixed connection, a detachable connection, or an integral connection; they may be a mechanical connection or an electrical connection; they may be a direct connection, an indirect connection via an intermediate medium, or an internal communication between two elements. Those of ordinary skill in the art may understand the specific meanings of the above terms in the present application according to the actual circumstances.

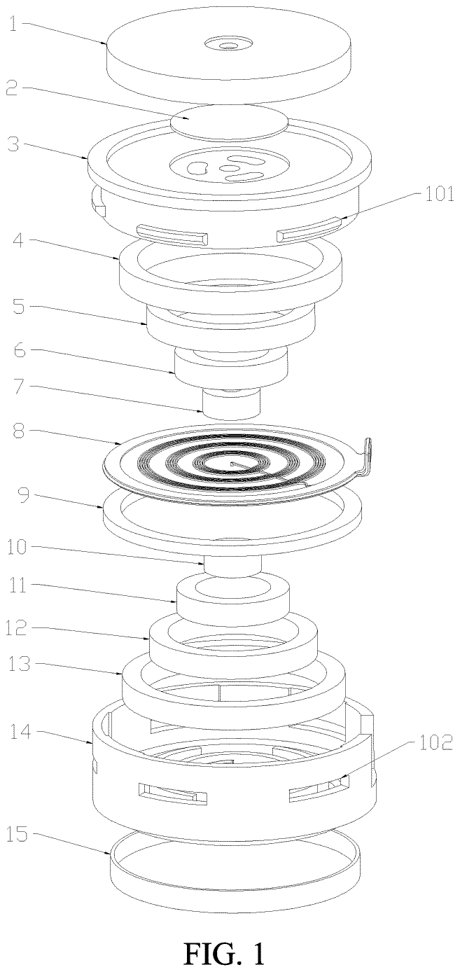

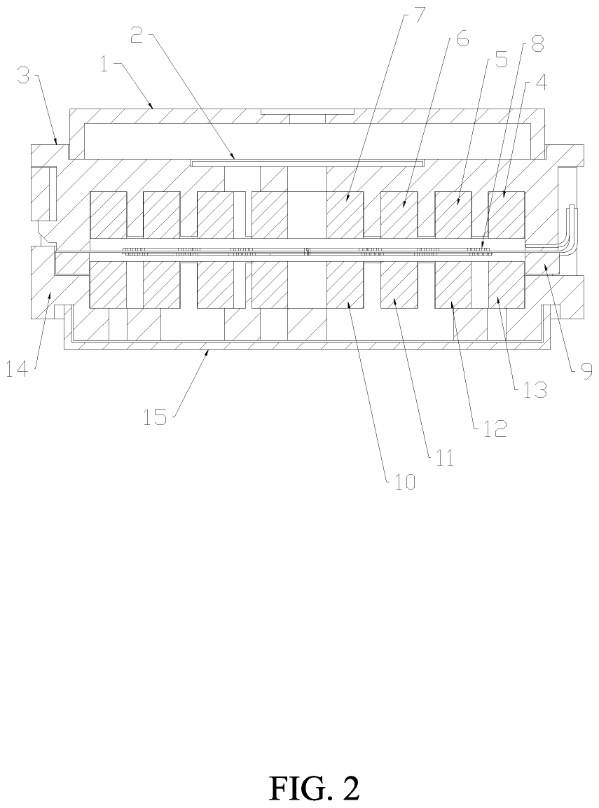

An earphone speaker structure, referring to FIG. 1 and FIG. 2, the upper magnetic ring frame 3 and the lower magnetic ring frame 14 mate precisely by providing six snap-fit positions; the upper magnetic ring frame 3 is embedded and fixedly mounted in the lower magnetic ring frame 14, and the upper magnetic ring frame 3 and the lower magnetic ring frame 14 are formed by high-precision plastic molding. The diaphragm assembly 8 is disposed between the upper magnetic ring frame 3 and the lower magnetic ring frame 14, the diaphragm assembly 8 partitions the interior of the upper magnetic ring frame 3 and the lower magnetic ring frame 14, the plurality of magnetic rings are respectively disposed above and below the diaphragm assembly 8, the upper central magnetic ring 7, the upper small magnetic ring 6, the upper middle magnetic ring 5, and the upper large magnetic ring 4 are provided as a group in the upper magnetic ring frame 3, the lower central magnetic ring 10, the lower small magnetic ring 11, the lower middle magnetic ring 12, and the lower large magnetic ring 13 are provided as a group in the lower magnetic ring frame 14, the magnetic rings of each group have a uniform thickness in the horizontal direction, and diameters thereof increase sequentially from an inner side to an outer side, and the magnetic rings are sequentially mounted in a concentric annular structure in the upper magnetic ring frame 3 and the lower magnetic ring frame 14 in the vertical direction. Two pieces each of the central, small, middle and large magnetic rings are independently magnetized to ensure accurate polarity. Specific polarities are as follows: the upper large magnetic ring 4, the upper small magnetic ring 6, the lower large magnetic ring 13, and the lower small magnetic ring 11 are N poles; and the upper central magnetic ring 5, the upper central magnetic ring 7, the lower middle magnetic ring 12, and the lower central magnetic ring 10 are S poles. The NSNS polarity arrangement design improves the uniformity of magnetic force coverage and reduces acoustic distortion.

Further, the upper magnetic ring frame 3 and the lower magnetic ring frame 14 are respectively provided with a plurality of layers of concentric annular grooves corresponding to sizes of the magnetic rings at all levels, the magnetic rings are mounted in the upper magnetic ring frame 3 and the lower magnetic ring frame 14 provided with the concentric grooves in order of size, and are fixed by means of structural grooves and adhesive dispensing to ensure that the magnetic rings correspond vertically to each other and are arranged in a concentric ring structure from the inside to the outside. The magnetic rings are mounted in a nested manner with adhesive dispensing, thereby avoiding misalignment and loosening. The six snap-fit positions include six snap fasteners 101 and six snap grooves 102 horizontally wound on the upper magnetic ring frame 3 or the lower magnetic ring frame 14 to improve connection stability. An assembly tolerance of the snap-fit positions is controlled within a range of ±0.01 mm to improve assembly precision. Through high-precision control, upon assembly, an entirely sealed upper and lower sound cavity is integrally formed. The dimensional tolerance of the snap-fit positions is controlled within a range of ±0.01 mm by means of high-precision mold manufacturing, engineering plastic material selection control, injection molding parameter adjustment, and precision inspection, such that a high-sealing connection between the magnetic ring frames is achieved, so as to avoid air leakage or displacement, and ensure the airtightness and structural stability of the upper and lower sound cavities of the speaker.

Further, a 3M sealant 9 is disposed on upper and lower sides of the diaphragm assembly 8 for hermetic assembly between the upper magnetic ring frame 3 and the lower magnetic ring frame 14; the “3M sealant” refers to an annular sealant product for sealing and vibration resistance of electronic components widely used in the trademark products of, which feature excellent adhesion, sealing performance and anti-vibration performance. In the present technical solution, sealants of other brands with similar properties may also be used instead, and the 3M brand is not intended to be the sole limitation. The diaphragm assembly 8 is a double-sided circuit planar diaphragm. Welding leads are of a direct welding structure, which means that an output lead of the diaphragm assembly is electrically connected to a welding point (for example, a lead pad or an electrode terminal is embedded into the upper and lower magnetic ring frames) preset in the speaker structure by way of direct welding. Compared with conventional wire-wound connection, the direct welding mode has the advantages of simple structure, stable welding point, small electrical energy loss and the like, which is beneficial to improving the product consistency and reliability. That is, the diaphragm electrode is directly welded to the conductive terminal or circuit by high-precision automatic welding equipment, so as to realize an integrated fixed connection in both physical and electrical aspects. Direct welding forms firm intermetallic contact, significantly reducing contact resistance and improving signal transmission efficiency. The welding joints are encapsulated by solder or other conductive alloys, making them resistant to erosion by oxygen and moisture in the air, thereby fundamentally eliminating conduction failures caused by oxidation.

The welding points feature a fixed structure and strong anti-loosening performance. They are not prone to loosening or falling off even under strong vibration or long-term use, making them particularly suitable for the high-reliability requirements of sports or portable headphones. The welding process can be automatically controlled, and the solder joint position, temperature and solder amount can be operated in a standardized manner, ensuring consistency and quality stability in mass production.

Further, the 3M sealant 9 hermetically adheres the diaphragm assembly 8 to the lower magnetic ring frame 14, thereby forming a first sound cavity; and an upper cover 1 is disposed on an outer side of the upper magnetic ring frame 3, and the upper cover 1 is hermetically connected to the upper magnetic ring frame 3 by dispensing an adhesive, thereby forming a second sound cavity, such that the speaker is constructed as a closed dual-sound-cavity structure. As a core structure for sound wave conversion, an 3M sealant 9 is disposed on upper and lower sides of the diaphragm assembly 8 for achieving a reliable airtight connection between the upper magnetic ring frame 3 and the lower magnetic ring frame 14. The sealant not only provides mechanical fixation, but also undertakes the key functions of sealing the sound cavity, preventing sound wave leakage and reducing energy loss. Through the 3M sealant 9, the speaker is simply and precisely assembled, such that the assembly clearance of the speaker is precisely controlled. The gap between the diaphragm and the magnetic ring is accurate to 0.02-0.25 MM, so that the product precision is increased, and the batch production efficiency is improved. The used 3M sealant is a high-performance, high-temperature-resistant, low-volatility annular colloid, with a coating shape matching the structures of the edge of the diaphragm assembly and the frames, thereby ensuring that the sealing surface is uniformly covered with strong adhesion. In terms of structure, the diaphragm assembly 8 is the double-sided circuit planar diaphragm, upper and lower circuits of which are achieved by a flexible printing process and are connected to conductive points directly by a direct welding lead structure, without conventional copper dot contact structures, such that poor contact and potential open circuits caused by oxidation during long-term use are effectively avoided, and electrical conduction performance and product consistency are significantly improved. This structure simplifies the production process, enhances the structural stability, and reduces the spatial occupation, thereby creating conditions for a compact design of the entire sound cavity. During assembly, the 3M sealant 9 hermetically adheres the diaphragm assembly 8 to the lower magnetic ring frame 14, thereby forming a first sound cavity. The volume and damping parameter of the first sound cavity, as a back cavity of the diaphragm, are determined by precise calculation, such that the diaphragm can obtain more excellent resilience characteristics and resonance control during operation, thereby improving the mid-low frequency response and dynamic range. In addition, an upper cover 1 covers the outer side of the upper magnetic ring frame 3, and the upper cover is hermetically connected to the upper magnetic ring frame 3 by way of precise adhesive dispensing, thereby enclosing a closed second sound cavity. The second sound cavity is located on the front surface of the diaphragm and is structurally a mirror image of the first sound cavity. The first sound cavity and the second sound cavity work together in the acoustic system to improve the overall acoustic performance of the speaker. The dual-sound-cavity structure can effectively control airflow balance of a sound wave on both sides of the diaphragm and reduce acoustic phase interference and cavity resonance, such that the sound quality is clearer and more stable, with significant advantages especially in improving high-frequency response and resolution.

Further, a protective steel mesh 15 is disposed on an outer side of the lower magnetic ring frame 14 for preventing dust and preventing foreign matter from entering, which improves the durability and prolongs the service life. A tuning mesh 2 is disposed in the upper cover 1 to adjust air circulation and optimize frequency response characteristics. The outer diameter of the speaker structure may be 8 mm, 11 mm, or 15 mm, thereby supporting various outer diameter models and adapting to the requirements of different earphone products.

The foregoing description of the disclosed embodiments enables those skilled in the art to make or use the present disclosure. Various modifications to these embodiments will be readily apparent to those skilled in the art, and the generic principles defined herein may be applied to other embodiments without departing from the spirit or scope of the present disclosure. Therefore, the present disclosure shall not be limited to the embodiments shown herein, but is to be accorded the widest scope consistent with the principles and novel features disclosed herein.

What is claimed is:

1. An earphone speaker structure, comprising:
an upper magnetic ring frame and a lower magnetic ring frame, which mate precisely by providing six snap-fit positions; a diaphragm assembly, disposed between the upper magnetic ring frame and the lower magnetic ring frame; and a plurality of magnetic rings, comprising an upper central magnetic ring and a lower central magnetic ring, an upper small magnetic ring and a lower small magnetic ring, an upper middle magnetic ring and a lower middle magnetic ring, and an upper large magnetic ring and a lower large magnetic ring, which form two groups of magnetic ring structures corresponding vertically to each other, wherein the magnetic rings of each group have a uniform thickness in the horizontal direction, and diameters thereof increase sequentially from an inner side to an outer side, and the magnetic rings are sequentially mounted in a concentric annular structure in the upper magnetic ring frame and the lower magnetic ring frame in the vertical direction; a 3M sealant is disposed on upper and lower sides of the diaphragm assembly for hermetic assembly between the upper magnetic ring frame and the lower magnetic ring frame; and the diaphragm assembly is a double-sided circuit planar diaphragm, and welding leads are of a direct welding structure.

2. The earphone speaker structure according to claim 1, wherein the 3M sealant hermetically adheres the diaphragm assembly to the lower magnetic ring frame, thereby forming a first sound cavity; and an upper cover is disposed on an outer side of the upper magnetic ring frame, and the upper cover is hermetically connected to the upper magnetic ring frame by dispensing an adhesive, thereby forming a second sound cavity, such that the speaker is constructed as a closed dual-sound-cavity structure.

3. The earphone speaker structure according to claim 1, wherein the upper magnetic ring frame and the lower magnetic ring frame are respectively provided with a plurality of layers of concentric annular grooves corresponding to sizes of the magnetic rings at all levels, and the magnetic rings are mounted in a nested manner with adhesive dispensing, thereby avoiding misalignment and loosening.

4. The earphone speaker structure according to claim 1, wherein the six snap-fit positions comprise six snap fasteners and six snap grooves horizontally wound on the upper magnetic ring frame and the lower magnetic ring frame to improve connection stability.

5. The earphone speaker structure according to claim 4, wherein an assembly tolerance of the snap-fit positions is controlled within a range of ±0.01 mm to improve assembly precision.

6. The earphone speaker structure according to claim 1, wherein the 3M sealant is of an annular encapsulation structure to ensure sealing performance and anti-vibration performance.

7. The earphone speaker structure according to claim 1, wherein a protective steel mesh is disposed on an outer side of the lower magnetic ring frame for preventing dust and preventing foreign matter from entering.

8. The earphone speaker structure according to claim 1, wherein a tuning mesh for regulating a ventilation rate of the speaker is disposed on an outer side of the upper magnetic ring.

9. The earphone speaker structure according to claim 1, wherein an outer diameter of the speaker structure is 8 mm, 11 mm or 15 mm, which is suitable for integrated assembly of different types of earphones.
